(19) United States
(12) Patent Application Publication
(10) Pub. No.: US 2025/0214209 A1
(43) Pub. Date: Jul. 3, 2025

(54) BIDIRECTIONAL MAGNETIC EXTRACTOR TOOL

(71) Applicant: Apex Brands, Inc., Apex, NC (US)

(72) Inventors: Zhihong FU, Cary, NC (US); Robert STRUBLE, Fuquay-Varina, NC (US)

(21) Appl. No.: 18/838,030

(22) PCT Filed: Feb. 13, 2023
(86) PCT No.: PCT/US2023/012910

§ 371 Date: Aug. 13, 2024

Related U.S. Application Data
(60) Provisional application No. 63/309,840, filed on Feb. 14, 2022.

(51) Int. Cl. B25B 23/12; B25B 23/00; B25B 27/18

(52) U.S. Cl. CPC B25B 23/12; B25B 23/0035; B25B 27/18

(57) ABSTRACT

An extractor tool may include a driven end configured to receive drive power from a driving device, a drive end configured to interface with a fastener, and a body portion extending between the driven end and the drive end about an axis of the extractor tool. The drive end may include a fastener engagement recess which may extend into the body portion and coaxial with the body portion. The fastener engagement recess may include a plurality of engagement ribs that may be configured to engage with the fastener such that the fastener is drivable in either a clockwise or a counterclockwise direction while avoiding contact with corner portions of the fastener. The extractor tool may further include a magnet carrier assembly which may be operably coupled to a magnet which may be configured to engage with the fastener at different depths of the fastener engagement recess.

### TECHNICAL FIELD

Example embodiments generally relate to power equipment and, more particularly, relate to improvements for an extractor tool configured to remove or drive fastening nuts or other drivable components in either direction.

### BACKGROUND

Socket tools, such as nut drivers, are familiar tools for both fastening and removing nuts, bolts, and other drivable components or fasteners. These tools commonly have removable heads that interface with the ratchet, socket wrench, drill, impact gun or other driver on one side and interface with one of various different sizes of nut, bolt head, or other fastener on the other side. Because high torque is often applied through these tools, and high strength and durability is desirable, the sockets are traditionally made of a metallic material such as iron or steel.

Sockets are generally made in sets that include different heads for each common size of fastener. The corresponding size for each common size of fastener is often the best tool that can be used to drive the fastener in either the tightening or loosening direction. In this regard, the shape of the socket and fastening nut or fastener head is matched (e.g., typically hexagonal in shape), and the sizes are also very closely matched to ensure maximum surface contact and therefore even distribution of force to all of the faces of the fastening nut or fastener head. However, if the wrong size of socket is used, or if an adjustable wrench or plier is used, it can often be the case that forces get concentrated on the corners of the fastening nuts (i.e., the transitions between the adjacent faces that form the familiar hexagonal shape). These concentrated forces can damage or strip the corners of the fastening nut or fastener head so that the corners become rounded. When the corners become sufficiently rounded, traditional sockets will slip when a significant force is applied or the socket may even be rendered useless and no longer be able to grip the fastener sufficiently to move it one or both directions. The risk of rounding can be exacerbated when fasteners are exposed to water, harsh chemicals, or other environments that can rust or corrode the fastener nut or head.

Although numerous designs of bolt extraction tools have been proposed, these designs assume that the operator can replace the damaged fastener with a new (undamaged) fastener after removal of the damaged fastener. However, there are many instances where it is necessary to use the same (i.e., damaged) fastener that was removed. Additionally, in many cases, fasteners are located in hard-to-reach places, making it difficult to successfully remove the fastener and keep track of it after removal. It is also possible that driving the damaged fastener in the clockwise direction (or counterclockwise direction) is advantageous prior to driving the damaged fastener in the counterclockwise direction (or clockwise direction). In other words, in some cases, a directional change may facilitate driving of the damaged fastener in any direction. Additionally, in some cases, the stripping of a fastener may be so severe that even conventional unidirectional extraction sockets in conventional extraction socket sets are not capable of gripping the fastener and merely rotate around the fastener without moving it.

Thus, it may be desirable to provide a new design for an extractor tool with improved performance, including a capability for bi-directionally gripping, driving, removing, and retaining fasteners, including severely rounded, corroded, or damaged fasteners.

### BRIEF SUMMARY OF SOME EXAMPLES

Some example embodiments may provide for a bidirectional extractor tool. The extractor tool may include a driven end configured to receive drive power from a driving device, a drive end configured to interface with a fastener, and a body portion extending between the driven end and the drive end about an axis of the extractor tool. The drive end may include a fastener engagement recess which may extend into the body portion and coaxial with the body portion. The fastener engagement recess may include a plurality of engagement ribs that may be configured to engage with the fastener such that the fastener is drivable in either a clockwise or a counterclockwise direction while avoiding contact with corner portions of the fastener. The engagement ribs may extend inwardly toward each other to define an inner diameter between opposing ribs. The inner diameter may be greatest at the drive end and may decrease along at least a portion of a length of the engagement ribs extending toward the driven end. The extractor tool may further include a magnet carrier assembly which may be operably coupled to a magnet which may be configured to engage with the fastener at different depths of the fastener engagement recess.

In another example embodiment, the extractor tool may include a driven end configured to receive drive power from a driving device, a drive end configured to interface with a fastener, and a body portion extending between the driven end and the drive end about an axis of the extractor tool. The drive end may include a fastener engagement recess extending into the body portion and coaxial with the body portion. The fastener engagement recess may include a plurality of engagement ribs that may be configured to engage with the fastener such that the fastener is drivable in either a clockwise or a counterclockwise direction while avoiding contact with corner portions of the fastener. The engagement ribs may extend inwardly toward each other to define an inner diameter between opposing ribs. The inner diameter may be greatest at the drive end and may decrease along at least a portion of a length of the engagement ribs extending toward the driven end. The fastener engagement recess may further include a magnet carrier assembly which may be operably coupled to a magnet which may be configured to engage with the fastener at different depths of the fastener engagement recess. A carrier retention assembly may be integrally formed from the body portion and may be configured to support the magnet carrier assembly in a rest position when there is no fastener in the fastener engagement recess.

In another example embodiment, the extractor tool may include a driven end configured to receive drive power from a driving device, a drive end configured to interface with a fastener, and a body portion extending between the driven end and the drive end about an axis of the extractor tool. The drive end may include a fastener engagement recess extending into the body portion and coaxial with the body portion. The fastener engagement recess may include a plurality of engagement ribs that may be configured to engage with the fastener such that the fastener is drivable in either a clockwise or a counterclockwise direction while avoiding contact with corner portions of the fastener. The engagement ribs may extend inwardly toward each other to define an inner diameter between opposing ribs. The inner diameter may be greatest at the drive end and may decrease along at least a portion of a length of the engagement ribs extending toward the driven end. The fastener engagement recess may further include a magnet carrier assembly which may be operably coupled to a magnet which may be configured to engage with the fastener at different depths of the fastener engagement recess. A carrier retention assembly may be configured to support the magnet carrier assembly in a rest position when there is no fastener in the fastener engagement recess. The carrier retention assembly may be an annular ring formed separate from the body portion and may be secured within the body portion via a press fit.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1A illustrates a perspective view of a drive end of an extraction tool according to an example embodiment;

FIG. 1B illustrates a perspective view of a driven end of the extraction tool according to an example embodiment;

FIG. 2A illustrates a top view of the drive end of the extraction tool according to an example embodiment;

FIG. 2B illustrates a bottom view of the driven end of the extraction tool according to an example embodiment;

FIG. 2C illustrates a top view of a fastener according to an example embodiment;

FIG. 3A illustrates a cross section view of the extraction tool taken along line A-A in FIG. 2A according to an example embodiment;

FIG. 3B illustrates a close up cross section view of the extraction tool of FIG. 3A according to an example embodiment;

FIG. 4A illustrates a cross section view of the extraction tool taken along line B-B in FIG. 2B according to an example embodiment;

FIG. 4B illustrates a close up cross section view of the extraction tool of FIG. 4A according to an example embodiment;

FIG. 5A illustrates an exploded view of the extraction tool according to an example embodiment; and

FIG. 5B illustrates an exploded view of the extraction tool according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

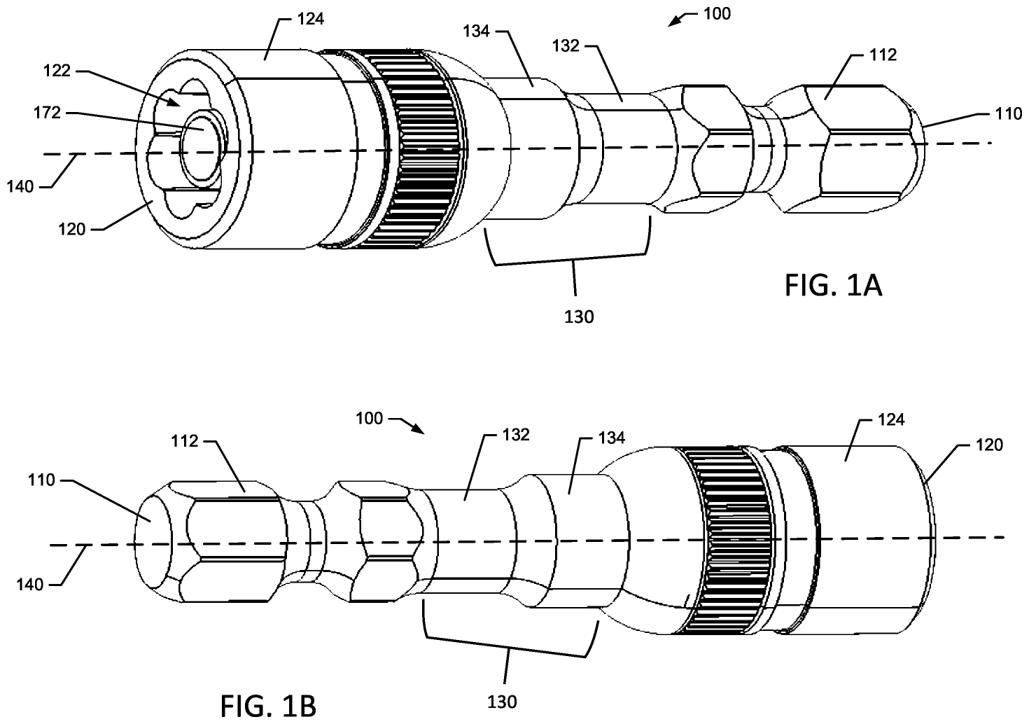

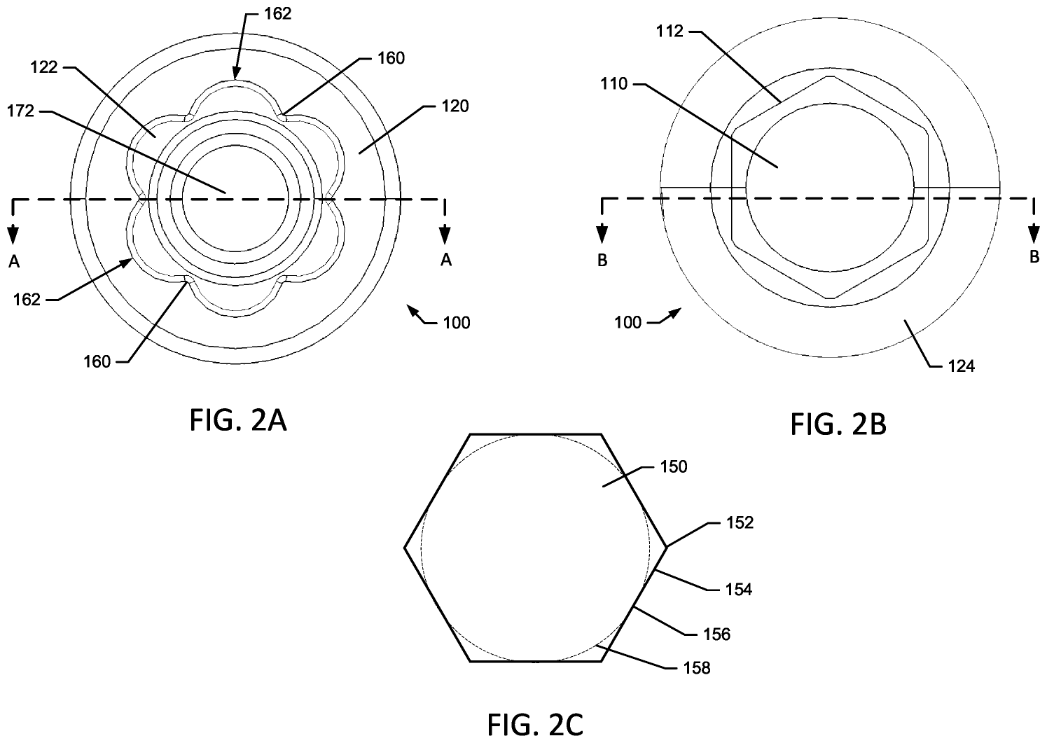

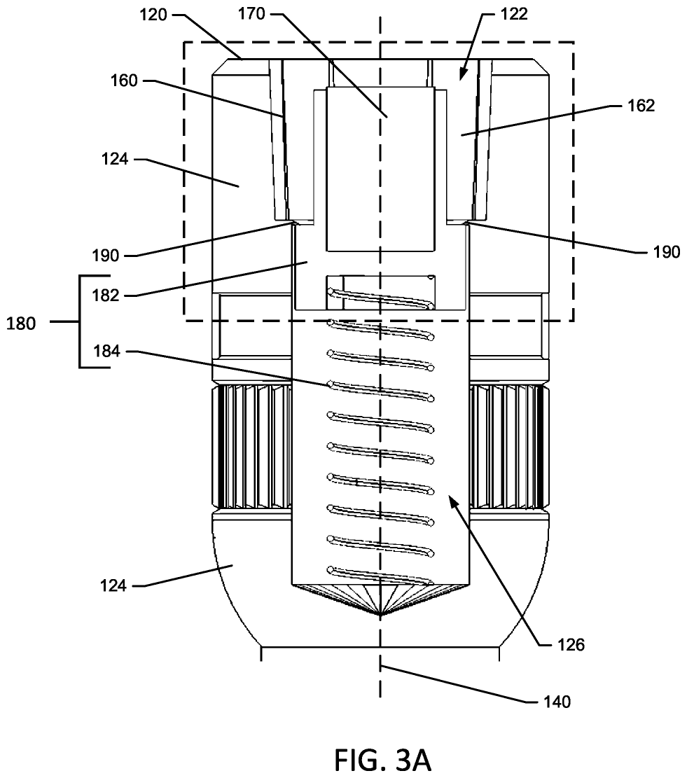

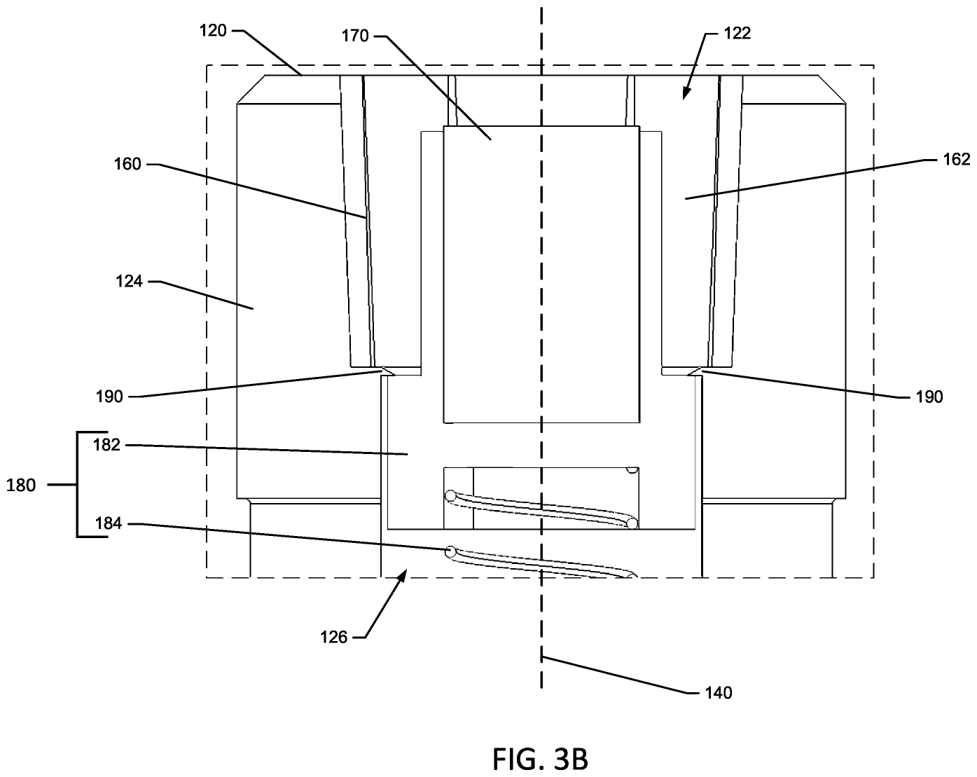

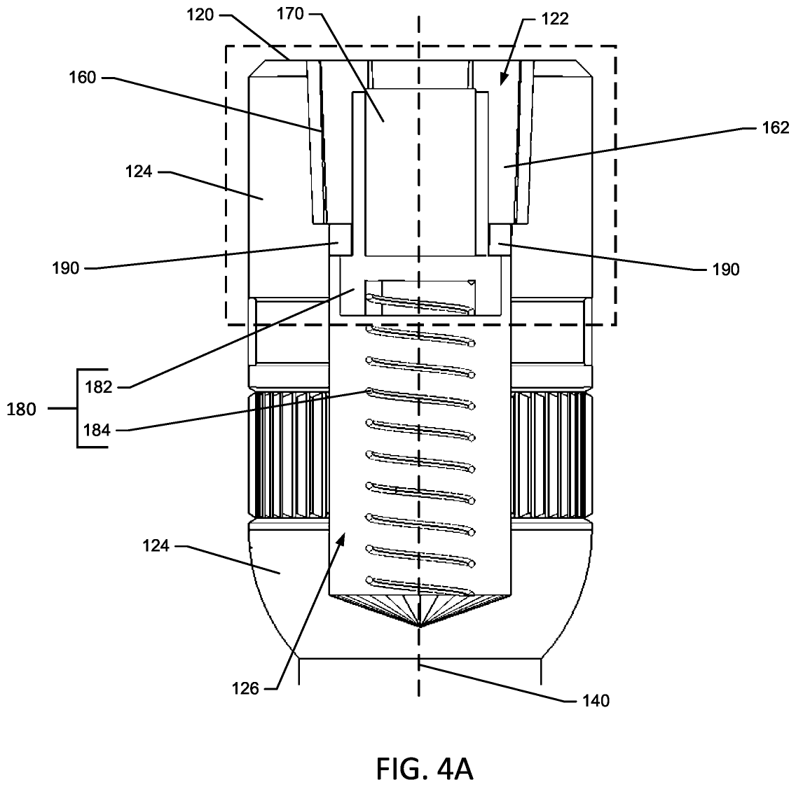

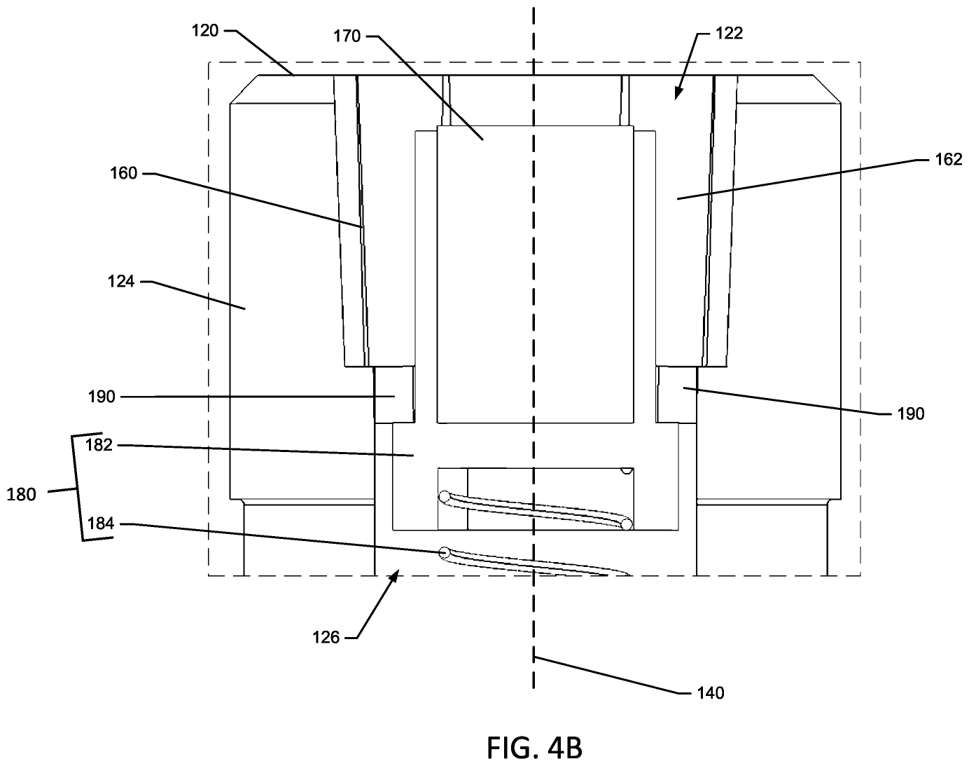

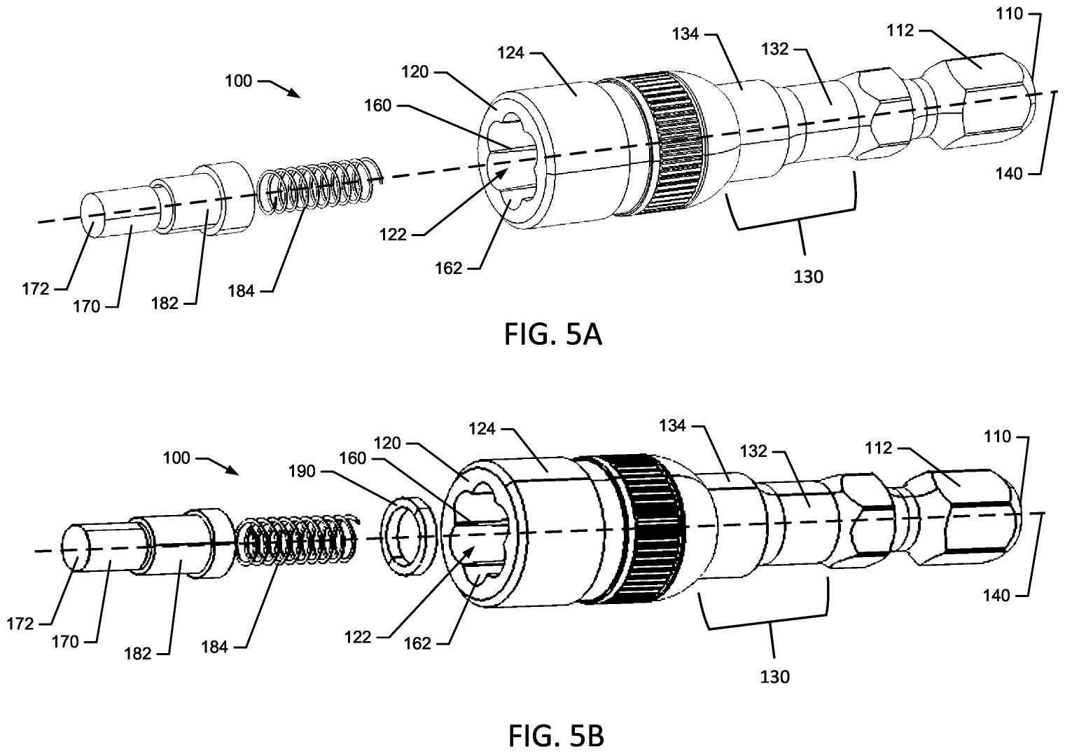

As indicated above, some example embodiments may relate to the provision of a bidirectional extractor tool. Tools associated with example embodiments can therefore be used to drive fasteners (including damaged fastening nuts, screws, or bolts with rounded corners) in either direction. Further, the tools according to some example embodiments may be capable of retaining a fastener following the extraction of said fastener by way of a floating magnet located within the body portion of the extractor tool. Moreover, tools according to example embodiments may be more capable of performing successful extractions because the sets include intermediate sizes (including intermediate sizes between adjacent standard sizes of both metric and Society of Automotive Engineers (SAE) socket sizes). FIG. 1, which is defined by FIGS. 1A and 1B, illustrates perspective views of a bidirectional extractor tool 100 that is configured to drive fasteners (including damaged fasteners) in either direction (i.e., clockwise and counterclockwise or tightening and loosening directions). According to some embodiments, the extractor tool 100 may also be referred to as a “bolt biter”. FIG. 2, which is defined by FIGS. 2A, 2B and 2C, illustrates front and back views of the extractor tool 100 to illustrate views of a driven end 110 and a drive end 120 of the extractor tool 100, and illustrates a top view of a hex head fastener (FIG. 2C). FIG. 3, which is defined by FIGS. 3A and 3B, illustrates a cross section view (FIG. 3A) and a close up of that cross section view (FIG. 3B) of the extractor tool 100 in accordance with an example embodiment. FIG. 4, which is defined by FIGS. 4A and 4B, illustrates a cross section view (FIG. 4A) and a close up of that cross section view (FIG. 4B) of the extractor tool 100 in accordance with an example embodiment. FIGS. 5A and 5B illustrate exploded views of the extraction tool according to example embodiments.

Referring to FIGS. 1 and 2, it can be appreciated that the driven end 110 of the extractor tool 100 may include a drive projection 112 that may be configured to operably couple the extractor tool 100 to an external driving device that may provide torque. In this regard, the drive projection 112 may be the part of the extractor tool 100 that receives a torque force. In some embodiments, the driving device may be a handheld power tool such as a drill or an impact driver. In an example embodiment, the drive projection 112 of the extractor tool 100 may be configured to have a non-circular outer surface to facilitate translating torque from the driving device to the extractor tool 100. For example, the drive projection 112 may have a hexagonally shaped cross section to facilitate engagement with a driving device such as a drill. However, in some cases, the drive projection 112 may have a circular or other shaped outer surface, and thus a circular or other shaped cross section. Additionally, and as stated above, the driving forces may be applied in either direction, as will be discussed in greater detail below.

The drive end 120 may be the end of the extractor tool 100 that interfaces with a fastener (e.g., a fastening nut such as a hex nut, a fastening head such as a hex head on a bolt or screw, or other fastener driven by a force applied to the periphery of the fastener nut or fastener head) to drive the fastener responsive to the driving force provided by the driving device to the driven end 110. The drive end 120 may be shaped substantially as a circular end face that includes a fastener engagement recess 122 that is configured to engage the fastener to allow driving in either of the clockwise or counterclockwise directions. The extractor tool 100 may include a body portion 124 that extends from the drive end 120 up to a shank 130. The body portion 124 may be a substantially cylindrical body that could have varying desired diameters based on the size of the engagement recess 122 as well as the strength requirements, tool material, manufacturing requirements, and access requirements for the particular application. Typically, the diameter of the body portion 124 will be selected based on a size of fastener that the fastener engagement recess 122 is designed to mate with. In this regard, for example, if the fastener engagement recess 122 is designed to mate with a ½ inch fastener, the diameter of the body portion 124 may be selected to be at least large enough to include the ½ inch sized fastener engagement recess 122 plus sufficient additional support material to allow large amounts of torque to be applied to the fastener via the extractor tool 100. In some cases, additional size of the diameter may range from 10% to 50%, but other sizes are also possible.

The shank 130 may operably couple the driven end 110 to the drive end 120. Thus, the shank 130, may assist with translating torque from the driving device into rotational motion of the drive end 120. The driven end 110, and more particularly the drive projection 112, may be operably coupled to a first portion 132 of the shank 130 and the body portion 124 may be operably coupled to a second portion 134 of the shank 130. Therefore, the shank 130 may be subject to high torsional loading due to the shank 130 forming a connection between the driven end 110 and the body portion 124, both of which may experience opposing forces while the extractor tool 100 is in use. In some embodiments, the first portion 132 may be machined to have a different diameter than the second portion 134. In some embodiments, the first portion 132 may have a smaller diameter than the second portion 134. In some other embodiments, the first portion 132 may have a larger diameter than the second portion 134. In still some other embodiments, the first portion 132 and the second portion 134 may have the same size diameter.

As can be appreciated from FIGS. 1 and 2, the end faces of the drive end 120 and the driven end 110 each lie in planes that are substantially parallel to each other and spaced apart from each other by the longitudinal length of the extractor tool 100. Meanwhile, the extractor tool 100 may have an axis 140 about which the extractor tool 100 rotates when forces are applied thereto. The axis 140 may form the longitudinal centerline of the extractor tool 100 and the body portion 124, and may extend substantially perpendicular to the end faces of the driven end 110 and the drive end 120. The extractor tool 100 may have an overall length measured along the axis 140 from the end face of the drive end 120 to the end face of the driven end 110. Although any suitable length may be used, in some embodiments, the extractor tool 100 may have an overall length of 2 inches (roughly 48 mm), and in some other embodiments, the extractor tool 100 may have an overall length of 6 inches (roughly 150 mm).

Referring specifically to FIG. 2C, an example of the fastener 150 is shown, and may include six corner portions 152 disposed between six side faces 154. The six side faces 154 form a hexagonal shape where each adjacent set of side faces 154 meet at the corner portions 152. The side faces 154 may be substantially straight or flat faces that extend substantially parallel to an axis of the fastener 150. Opposing pairs of the side faces 154 may lie in planes that are parallel to each other. A midpoint 156 of each of the six side faces 154 may be disposed substantially half way between corner portions 152 that are disposed at respective ends of each respective one of the six side faces 154. Over time, or responsive to one or more events that may damage the fastener 150, the corner portions 152 may be stripped or otherwise removed or deformed to form rounded corners 158 shown in FIG. 2C.

Referring now to FIGS. 3A-4B, cross section views of two example embodiments of the extractor tool 100 are shown. FIGS. 3A and 3B depict a first example embodiment and FIGS. 4A and 4B depict a second example embodiment. These figures clearly show the fastener engagement recess 122. The fastener engagement recess 122 may be configured to mate with the fastener 150 in such a way as to create a bidirectional engagement between the midpoint 156 of each of the side faces 154 of the fastener 150 (or a point near the midpoint 156) and the fastener engagement recess 122. In particular, the fastener engagement recess 122 may be defined by engagement ribs 160 that are defined between respective arc shaped grooves 162 or fluted portions. In some embodiments, the arc shaped grooves 162 and the engagement ribs 160 may each extend in a direction substantially parallel to the axis 140 to define the depth of the fastener engagement recess 122. In some other embodiments, the engagement ribs 160 may extend substantially non-linearly (e.g. spiraled) around the fastener engagement recess 122, and thus non-parallel to the axis 140. In either case, the engagement ribs 160 may maintain their radial spacing for an entire length of the engagement ribs 160.

A distance between engagement ribs 160 on opposing sides of the fastener engagement recess 122 may define the inside diameter of the fastener engagement recess 122. This distance (i.e., the inside diameter of the fastener engagement recess 122) may be tapered along at least a portion of (and perhaps all of) the length of the engagement ribs 160 such that the engagement ribs 160 are farther apart from each other at the driven end 120 end of the engagement recess 122 than at any other point along the length of the engagement ribs 160. The arc shaped grooves 162 may provide clearance for any corrosion, burring, or other remaining portions of the corner portion 152 that may exist near the rounded corners 158 of a damaged instance of the fastener 150. In some embodiments, the apex of each engagement rib 160, when viewed from the drive end 120 or a cross-section, substantially forms a corner, which may be a sharp corner that comes to point or may be somewhat rounded having a very small radius of curvature at the apex, such as a radius of substantially 0.5 mm or less.

Of course, on fastener 150 the distance between the side faces 154 on opposite sides of each other are normally equal along the entire length of the side faces 154. However, the engagement ribs 160 may be selected to define an initial inner diameter that is larger than the distance between the side faces 154 of the fastener 150 and may taper to an inner diameter that is smaller than the distance between the side faces 154 of the fastener. Thus, the tapered nature of the engagement ribs 160 will cause the engagement ribs 160 to be centered relative to the side faces 154 of the fastener 150 as the fastener 150 is inserted into the fastener engagement recess 122. In particular, after contact is first made between the engagement ribs 160 and the side faces 154, and the engagement ribs 160 slide along the side faces 154 for further insertion of the fastener 150 into the fastener engagement recess 122, the engagement ribs 160 automatically align with the midpoint 156 of the fastener 150 and begin to be tightly engaged therewith. Accordingly, when the fastener 150 is tightly engaged with and inserted into the fastener engagement recess 122, each of the six instances of the engagement ribs 160 will necessarily be in contact with a corresponding one of the midpoints 156 on a standard hex head or nut unless substantially worn or corroded unevenly. Even where substantially and unevenly worn, the fastener 150 will be automatically and substantially centered between at least two opposing ribs 160 that are in contact with a corresponding one of the midpoints 156 (or a point near to the midpoint).

The automatic centering of the engagement ribs 160 not only gives a tight engagement between the engagement ribs 160 and the side faces 154 (i.e., at the midpoint 156), but further creates such engagement in a way that means that turning the extractor tool 100 in either direction can be accomplished without repositioning the extractor tool 100. Thus, a reversible driving device that can be configured to drive in both directions may simply be switched between directions without ever disengaging the extractor tool 100 so that driving can be accomplished in either direction. This, of course, can provide a huge advantage over a specialized fastener removal tool that is only configured for removal. Given that conventional removal tools are only configured for removal, the designer's assumption is generally that the removed fastener will be discarded. Thus, care is not taken to preserve the integrity or condition of the fastener 150 by these specialized removers, and no opportunity for reuse is available to the operator. Operators that would either prefer to reuse the fastener 150, or must do so by necessity, are simply not offered any such option with such conventional removal tools. Furthermore, the arc shaped grooves 162 of extractor tool 100 ensure that no further damage is done to the rounded corners 158, and the engagement ribs 160 have engaged the side faces 154 at their strongest point (i.e., midpoint 156) to facilitate no further damage and potential reuse (or at least dual direction driving capability) for the fastener 150 when the extractor tool 100 of example embodiments is used. In contrast, conventional removal tools often cause significantly greater damage and deformation to the corners and/or leading edges of the fasteners 150.

In some embodiments, a magnet 170 may be disposed within the fastener engagement recess 122. In this regard, the magnet 170 may be configured to aid in retaining a fastener 150 within the fastener engagement recess 122, especially upon successful removal of the fastener 150. Accordingly, an engagement face 172 of the magnet 170 may magnetically adhere to a top surface of the fastener 150. The magnet 170 may be operably coupled to a magnet carrier assembly 180, which may operably couple the magnet 170 to the extractor tool 100, and more specifically, to the body portion 124. The magnet carrier assembly 180 may include a carrier base 182 and a spring 184. In some embodiments, the magnet carrier assembly 180 may be partially disposed in the fastener engagement recess 122, and partially disposed in a spring cavity 126 of the body portion 124, separate from the fastener engagement recess 122. In some embodiments, the spring cavity 126 may be a cylindrical cavity in which the spring 184 is permitted to compress and decompress responsive to forces exerted on the magnet 170 and the magnet carrier assembly 180 by fasteners 150 within the fastener engagement recess 122. The carrier base 182 may comprise a first side which may extend into the fastener engagement recess 122 and operably couple to the magnet 170. The carrier base 182 may also comprise a second side, which may be disposed entirely in the spring cavity 126 and be operably coupled to the spring 184. In some embodiments, the carrier base 182 may be operably coupled to the magnet 170 via a press fit. In some other embodiments, the carrier base 182 may be operably coupled to the magnet 170 via an adhesive.

The spring 184 may operably couple the carrier base 182 to the body portion 124 at a distal end of the spring cavity 126 relative to the carrier base 182. In some embodiments, the magnet 170 may be referred to as “floating” since the position of the magnet 170 may vary relative to the drive end 120 and along axis 140 depending on the particular dimensions associated with a head of the fastener 150 located within the fastener engagement recess 122. The ability of the magnet 170 to float may be advantageous for securing fasteners 150 of different types, sizes and degrees of wear within the fastener engagement recess 122. In this regard, the extractor tool 100 may be capable of driving a wider variety of fasteners 150 than a traditional extraction tool could drive, making the extractor tool 100 more universally applicable. When the fastener engagement recess 122 is empty and the extractor tool 100 is not in use, the magnet 170 may be disposed at a rest position where the engagement face 172 of the magnet 170 may be recessed roughly 1 mm below the drive end 120. On the other hand, when a fastener 150 is located within the fastener engagement recess 122, the magnet 170 may be capable of being displaced so that the engagement face 172 may be disposed at a distal end of the fastener engagement recess 122. In this regard, the spring 184 may be compressed along axis 140 and within spring cavity 126 responsive to a fastener 150 applying a force to the engagement face 172 of the magnet 170.

In some embodiments, the fastener engagement recess 122 and the spring cavity 126 may be separated by a carrier retention assembly 190. In this regard, the carrier retention assembly 190 may act as a stop position for the carrier base 182. Accordingly, when the carrier base 182, and thus the magnet 170, are disposed at the rest position, the spring 184 may be at a maximum level of decompression, and the carrier base 182 may be in contact with the carrier retention assembly 190. In some embodiments, the spring cavity 126 may have a greater depth than the fastener engagement recess 122. In this regard, the spring cavity 126 may be capable of accommodating the spring 184 (in both of its states of maximum compression and decompression), at least the second side of the carrier base 182, and at least a portion of the magnet 170 depending on the position of the magnet 170 determined by the dimensions of a fastener 150. In some cases, the engagement face 172 of the magnet 170 may be capable of movement within a range of 1 mm below the drive end 120 down to the carrier retention assembly 190.

In some embodiments, such as the embodiment depicted in FIGS. 3A and 3B (which are section views taken along line A-A), the carrier retention assembly 190 may be formed integrally with the body portion 124. In this regard, the carrier retention assembly 190 may be embodied as a lip formed from the material of the body portion 124. In some cases, the carrier retention assembly 190 may be pressed into a proper orientation for limiting the motion of the magnet carrier assembly 180 along axis 140. In other embodiments, such as the one depicted in FIGS. 4A and 4B (which are section views taken along line B-B), the carrier retention assembly 190 may be a separate part, such as an annular ring, that is held in place proximate to the spring cavity 126. In some embodiments, the carrier retention assembly 190 may be held in place via a press fit with the surrounding material of the body portion 124. In some other embodiments, the carrier retention assembly 190 may be held in place with an adhesive or any other appropriate methods of adhesion of the like.

FIGS. 5A and 5B depict the extractor tool 100 according to example embodiments shown in FIGS. 3A & 3B and 4A & 4B, respectively. In particular, FIGS. 5A and 5B show the extractor tool 100 in an exploded view so as to highlight each individual component of the magnet carrier assembly 180. In this regard, the magnet 170 is shown to operably couple with the first side of the carrier base 182 while the second side of the carrier base 182 is shown to operably couple with the spring 184. The magnet 170, the carrier base 182 and the spring 184 may then all fit into the body portion 124 of the extractor tool 100. In the embodiment of FIG. 5B, the carrier retention assembly 190 is also visible. In this regard, the carrier retention assembly 190 may be an annular ring formed separate from the body portion 124 and held in place in the body portion 124 via a press fit with the surrounding material of the body portion 124. In contrast, the embodiment of FIG. 5A may have a carrier retention assembly 190 integrally formed from the material of the inner sidewalls of the body portion 124, and thus the carrier assembly 190 may not be visible in the depicted exploded view.

Some example embodiments may provide for a bidirectional extractor tool. The extractor tool may include a driven end configured to receive drive power from a driving device, a drive end configured to interface with a fastener, and a body portion extending between the driven end and the drive end about an axis of the extractor tool. The drive end may include a fastener engagement recess which may extend into the body portion and coaxial with the body portion. The fastener engagement recess may include a plurality of engagement ribs that may be configured to engage with the fastener such that the fastener is drivable in either a clockwise or a counterclockwise direction while avoiding contact with corner portions of the fastener. The engagement ribs may extend inwardly toward each other to define an inner diameter between opposing ribs. The inner diameter may be greatest at the drive end and may decrease along at least a portion of a length of the engagement ribs extending toward the driven end. The extractor tool may further include a magnet carrier assembly which may be operably coupled to a magnet which may be configured to engage with the fastener at different depths of the fastener engagement recess.

The extractor tool of some embodiments may include additional features, modifications, augmentations and/or the like to achieve further objectives or enhance performance of the extractor tool. The additional features, modifications, augmentations and/or the like may be added in any combination with each other. Below is a list of various additional features, modifications, and augmentations that can each be added individually or in any combination with each other. For example, each of the engagement ribs may define an apex that may lie in a straight line and may extend a length of each of the engagement ribs. In some cases, each of the engagement ribs may define an apex that may extend a length of each of the engagement ribs and may be substantially non-linear (e.g. a spiral). In an example embodiment, the magnet carrier assembly may further include a carrier base and a spring. In some cases, the carrier base may include a first side operably coupled to the magnet and a second side operably coupled to the spring. In an example embodiment, a carrier retention assembly may be configured to support the magnet carrier assembly in a rest position when there is no fastener in the fastener engagement recess. In some cases, the carrier retention assembly may be integrally formed from the body portion. In an example embodiment, the carrier retention assembly may be an annular ring formed separate from the body portion and may be secured within the body portion via a press fit. In some cases, an engagement face of the magnet may be recessed relative to the drive end when the magnet is in the rest position. In an example embodiment, the fastener engagement recess may have a depth measured from the drive end to the carrier retention assembly. In some cases, the body portion may further include a spring cavity extending into the body portion and coaxial with the body portion. In an example embodiment, the spring cavity may be partitioned from the fastener engagement recess by the carrier retention assembly. In some cases, the depth of the fastener engagement recess may be less than a depth of the spring cavity. In an example embodiment, the driven end may include a hex-shaped drive projection for receiving drive power from the driving device.

Some example embodiments may provide for a bidirectional extractor tool. The extractor tool may include a driven end configured to receive drive power from a driving device, a drive end configured to interface with a fastener, and a body portion extending between the driven end and the drive end about an axis of the extractor tool. The drive end may include a fastener engagement recess extending into the body portion and coaxial with the body portion. The fastener engagement recess may include a plurality of engagement ribs that may be configured to engage with the fastener such that the fastener is drivable in either a clockwise or a counterclockwise direction while avoiding contact with corner portions of the fastener. The engagement ribs may extend inwardly toward each other to define an inner diameter between opposing ribs. The inner diameter may be greatest at the drive end and may decrease along at least a portion of a length of the engagement ribs extending toward the driven end. The fastener engagement recess may further include a magnet carrier assembly which may be operably coupled to a magnet which may be configured to engage with the fastener at different depths of the fastener engagement recess. A carrier retention assembly may be integrally formed from the body portion and may be configured to support the magnet carrier assembly in a rest position when there is no fastener in the fastener engagement recess.

The extractor tool of some embodiments may include additional features, modifications, augmentations and/or the like to achieve further objectives or enhance performance of the extractor tool. The additional features, modifications, augmentations and/or the like may be added in any combination with each other. Below is a list of various additional features, modifications, and augmentations that can each be added individually or in any combination with each other. For example, the magnet carrier assembly may further include a carrier base and a spring. In some cases, the carrier base may include a first side operably coupled to the magnet and a second side operably coupled to the spring. In an example embodiment, the fastener engagement recess may have a depth measured from the drive end to the carrier retention assembly. In some cases, the body portion may further include a spring cavity extending into the body portion and coaxial with the body portion. In an example embodiment, the spring cavity may be partitioned from the fastener engagement recess by the carrier retention assembly. In some cases, the depth of the fastener engagement recess may be less than a depth of the spring cavity. In an example embodiment, the driven end may include a hex-shaped drive projection for receiving drive power from the driving device.

Some example embodiments may provide for a bidirectional extractor tool. The extractor tool may include a driven end configured to receive drive power from a driving device, a drive end configured to interface with a fastener, and a body portion extending between the driven end and the drive end about an axis of the extractor tool. The drive end may include a fastener engagement recess extending into the body portion and coaxial with the body portion. The fastener engagement recess may include a plurality of engagement ribs that may be configured to engage with the fastener such that the fastener is drivable in either a clockwise or a counterclockwise direction while avoiding contact with corner portions of the fastener. The engagement ribs may extend inwardly toward each other to define an inner diameter between opposing ribs. The inner diameter may be greatest at the drive end and may decrease along at least a portion of a length of the engagement ribs extending toward the driven end. The fastener engagement recess may further include a magnet carrier assembly which may be operably coupled to a magnet which may be configured to engage with the fastener at different depths of the fastener engagement recess. A carrier retention assembly may be configured to support the magnet carrier assembly in a rest position when there is no fastener in the fastener engagement recess. The carrier retention assembly may be an annular ring formed separate from the body portion and may be secured within the body portion via a press fit.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A bidirectional extractor tool comprising:
a driven end configured to receive drive power from a driving device;
a drive end configured to interface with a fastener; and
a body portion extending between the driven end and the drive end about an axis of the extractor tool,
wherein the drive end comprises a fastener engagement recess extending into the body portion and coaxial with the body portion, the fastener engagement recess comprises a plurality of engagement ribs that are configured to engage with the fastener such that the fastener is drivable in either a clockwise or a counterclockwise direction while avoiding contact with corner portions of the fastener,
wherein the engagement ribs extend inwardly toward each other to define an inner diameter between opposing ribs,
wherein the inner diameter is greatest at the drive end and decreases along at least a portion of a length of the engagement ribs extending toward the driven end, and
wherein the extractor tool further comprises a magnet carrier assembly operably coupled to a magnet configured to engage with the fastener at different depths of the fastener engagement recess.

2. The extractor tool of claim 1, wherein each of the engagement ribs defines an apex that lies in a straight line extending a length of each of the engagement ribs.

3. The extractor tool of claim 1, wherein each of the engagement ribs defines an apex that extends a length of each of the engagement ribs and is substantially non-linear.

4. The extractor tool of claim 1, wherein the magnet carrier assembly further comprises a carrier base and a spring,
wherein the carrier base comprises a first side operably coupled to the magnet and a second side operably coupled to the spring, and
wherein a carrier retention assembly is configured to support the magnet carrier assembly in a rest position when there is no fastener in the fastener engagement recess.

5. The extractor tool of claim 4, wherein the carrier retention assembly is integrally formed from the body portion.

6. The extractor tool of claim 4, wherein the carrier retention assembly is an annular ring formed separate from the body portion and secured within the body portion via a press fit.

7. The extractor tool of claim 4, wherein an engagement face of the magnet is recessed relative to the drive end when the magnet is in the rest position.

8. The extractor tool of claim 1, wherein the fastener engagement recess has a depth measured from the drive end to the carrier retention assembly.

9. The extractor tool of claim 8, wherein the body portion further comprises a spring cavity extending into the body portion and coaxial with the body portion,
wherein the spring cavity is partitioned from the fastener engagement recess by the carrier retention assembly, and
wherein the depth of the fastener engagement recess is less than a depth of the spring cavity.

10. The extractor tool of claim 1, wherein the driven end comprises a hex-shaped drive projection for receiving drive power from the driving device.

11. A bidirectional extractor tool comprising:
a driven end configured to receive drive power from a driving device;
a drive end configured to interface with a fastener; and
a body portion extending between the driven end and the drive end about an axis of the extractor tool,
wherein the drive end comprises a fastener engagement recess extending into the body portion and coaxial with the body portion, the fastener engagement recess comprises a plurality of engagement ribs that are configured to engage with the fastener such that the fastener is drivable in either a clockwise or a counterclockwise direction while avoiding contact with corner portions of the fastener,
wherein the engagement ribs extend inwardly toward each other to define an inner diameter between opposing ribs,
wherein the inner diameter is greatest at the drive end and decreases along at least a portion of a length of the engagement ribs extending toward the driven end,
wherein the fastener engagement recess further comprises a magnet carrier assembly operably coupled to a magnet configured to engage with the fastener at different depths of the fastener engagement recess, and
wherein a carrier retention assembly is integrally formed from the body portion and configured to support the magnet carrier assembly in a rest position when there is no fastener in the fastener engagement recess.

12. The extractor tool of claim 11, wherein the magnet carrier assembly further comprises a carrier base and a spring, and
wherein the carrier base comprises a first side operably coupled to the magnet and a second side operably coupled to the spring.

13. The extractor tool of claim 11, wherein the fastener engagement recess has a depth measured from the drive end to the carrier retention assembly.

14. The extractor tool of claim 13, wherein the body portion further comprises a spring cavity extending into the body portion and coaxial with the body portion,
wherein the spring cavity is partitioned from the fastener engagement recess by the carrier retention assembly, and
wherein the depth of the fastener engagement recess is less than a depth of the spring cavity.

15. The extractor tool of claim 11, wherein the driven end comprises a hex-shaped drive projection for receiving drive power from the driving device.

16. A bidirectional extractor tool comprising:
a driven end configured to receive drive power from a driving device;
a drive end configured to interface with a fastener; and
a body portion extending between the driven end and the drive end about an axis of the extractor tool,
wherein the drive end comprises a fastener engagement recess extending into the body portion and coaxial with the body portion, the fastener engagement recess comprises a plurality of engagement ribs that are configured to engage with the fastener such that the fastener is drivable in either a clockwise or a counterclockwise direction while avoiding contact with corner portions of the fastener,
wherein the engagement ribs extend inwardly toward each other to define an inner diameter between opposing ribs,
wherein the inner diameter is greatest at the drive end and decreases along at least a portion of a length of the engagement ribs extending toward the driven end,
wherein the fastener engagement recess further comprises a magnet carrier assembly operably coupled to a magnet configured to engage with the fastener at different depths of the fastener engagement recess,
wherein a carrier retention assembly is configured to support the magnet carrier assembly in a rest position when there is no fastener in the fastener engagement recess, and
wherein the carrier retention assembly is an annular ring formed separate from the body portion and secured within the body portion via a press fit.

17. The extractor tool of claim 16, wherein the magnet carrier assembly further comprises a carrier base and a spring, and
wherein the carrier base comprises a first side operably coupled to the magnet and a second side operably coupled to the spring.

18. The extractor tool of claim 16, wherein the fastener engagement recess has a depth measured from the drive end to the carrier retention assembly.

19. The extractor tool of claim 18, wherein the body portion further comprises a spring cavity extending into the body portion and coaxial with the body portion,
wherein the spring cavity is partitioned from the fastener engagement recess by the carrier retention assembly, and
wherein the depth of the fastener engagement recess is less than a depth of the spring cavity.

20. The extractor tool of claim 16, wherein the driven end comprises a hex-shaped drive projection for receiving drive power from the driving device.
